(19) United States
(12) Patent Application Publication
(10) Pub. No.: US 2013/0284396 A1
(43) Pub. Date: Oct. 31, 2013

(54) CONTAINER DATA CENTER

(71) Applicant: FENG-CHI YANG, Tu-Cheng (TW)

(72) Inventor: FENG-CHI YANG, Tu-Cheng (TW)

(73) Assignee: HON HAI PRECISION INDUSTRY CO., LTD., Tu-Cheng (TW)

(21) Appl. No.: 13/491,578

(22) Filed: Jun. 7, 2012

(30) Foreign Application Priority Data
Apr. 28, 2012 (CN) 201210130157.7

(51) Int. Cl. G06F 1/20

(52) U.S. Cl. 165/45; 165/57; 62/260

(57) ABSTRACT

A container data center includes a container and an air collecting device. The air collecting device includes a collecting member, a first duct connected to the collecting member, and a second duct connected to the container. One end of the first duct opposite to the collecting member is pivotably connected to the second duct. The collecting member is rotatable to collect the airflow. The airflow flows through the first duct and the second duct to go into the container.

### BACKGROUND

1. Technical Field

The present disclosure relates to a container data center.

2. Description of Related Art

Many container data centers utilize fans for heat dissipation, which requires a lot of power. For container data centers positioned in an area of persistent winds, such as along the seashore, airflows caused by the wind could be used for dissipating heat, instead of using fans. However if an area with no clear prevailing wind is chosen, then the direction of the wind may change fro time to time, leading to unstable airflows, and because container data centers are large and not easily re-oriented, adjusting to changing wind directions is difficult and therefore heat dissipation by winds in conventional manner is currently unreliable.

### BRIEF DESCRIPTION OF THE DRAWINGS

Many aspects of the present embodiments can be better understood with reference to the drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an assembled, isometric view of an air collecting device of a container data center according to an exemplary embodiment.

FIG. 2 is similar to FIG. 1, but viewed from another perspective.

FIG. 3 is a using state view of FIG. 1.

FIG. 4 and FIG. 5 are assembled, schematic views of the container data center showing two different use states respectively.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

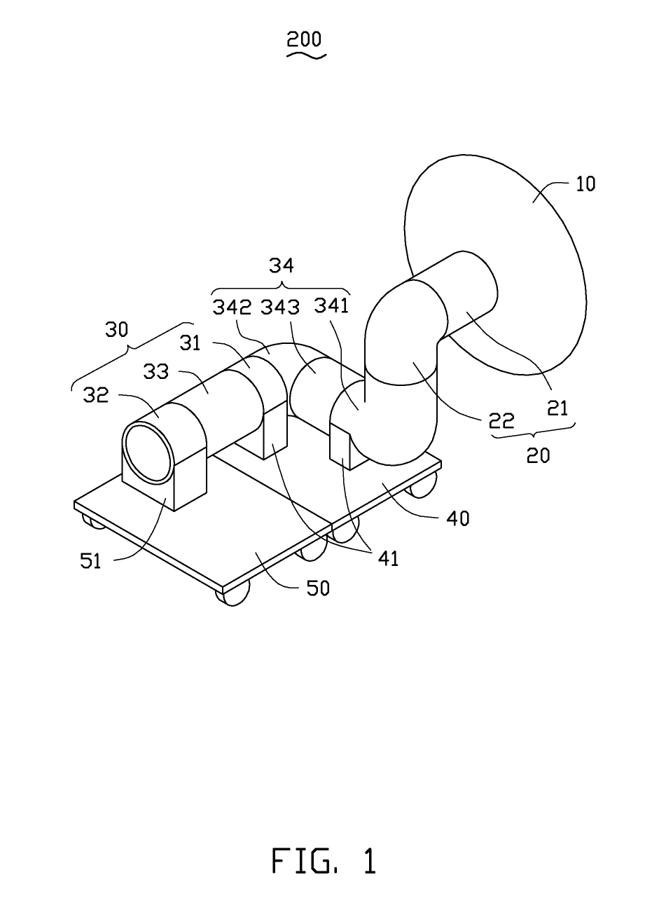

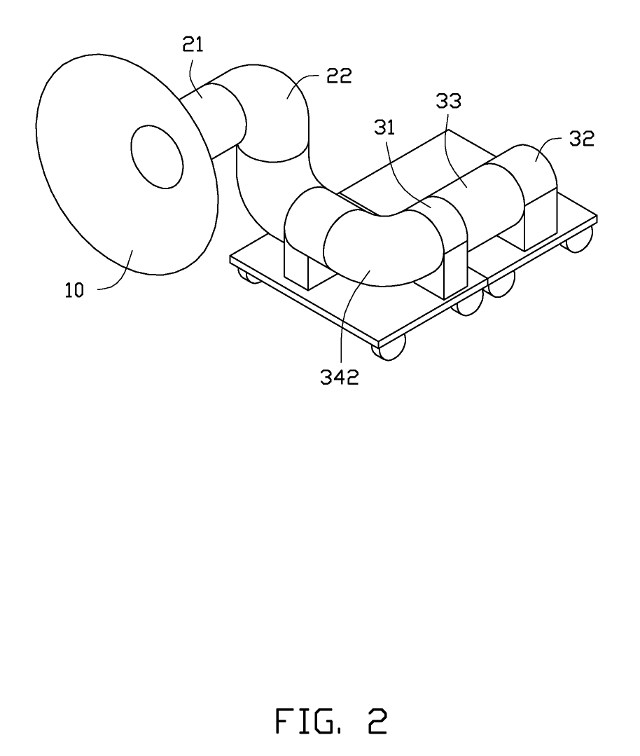

Referring to the FIGS. 1, 2, and 4, an embodiment of a container data center includes a container 100 and a plurality of air collecting devices 200 arranged beside the container 100. A plurality of electronic devices (not shown) is arranged in the container 100.

Each air collecting device 200 includes a horn-shaped collecting member 10 to collect air, a first duct 20, a second duct 30, a first movable member 40, and a second movable member 50.

The first duct 20 includes a straight portion 21 connected to the collecting member 10 with a first end, and a curved portion 22 connected to a second end of the straight portion 21 opposite to the collecting member 10. The second duct 30 includes a first mounting end 31, a second mounting end 32, a stretchable portion 33 connected between the first mounting end 31 and the second mounting end 32, and a connecting portion 34. The connecting portion 34 includes a first curved section 341, a second curved section 342, and a straight section 343 connected between the first curved section 341 and the second curved section 342. The curved portion 22 is pivotably connected to an end of the first curved section 341 opposite to the straight section 343. The second curved section 342 is connected to the first mounting end 31.

The first movable member 40 and the second movable member 50 are both small carts. The first mounting end 31 and the connecting portion 34 are respectively mounted to two supporting portions 41 with arc-shaped top surfaces, which protrude up from the first movable member 40. A supporting portion 51 with an arc-shaped top surface protrudes up from the second movable member 50, on which the second mounting end 32 is mounted. In another embodiment, the second curved section 342 may be rotated up about 90 degrees then be pivotably connected to the curved portion 22 directly.

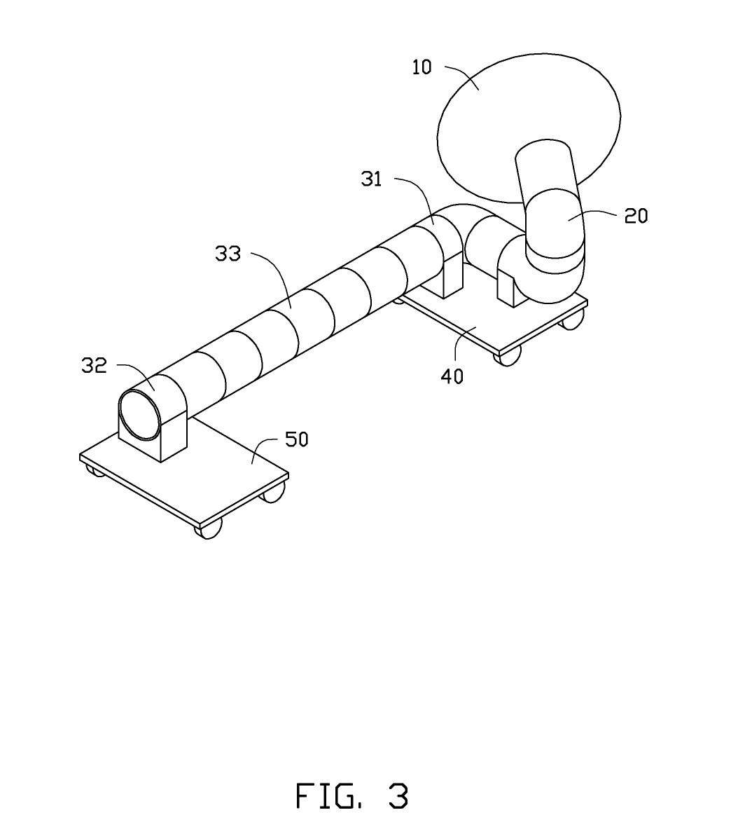

Referring to FIG. 3, when the first movable member 40 is moved away from the second movable member 50, the stretchable portion 33 is stretched. The first duct 20 is pivotable relative to the first curved section 341, to adjust the direction of the collecting member 10.

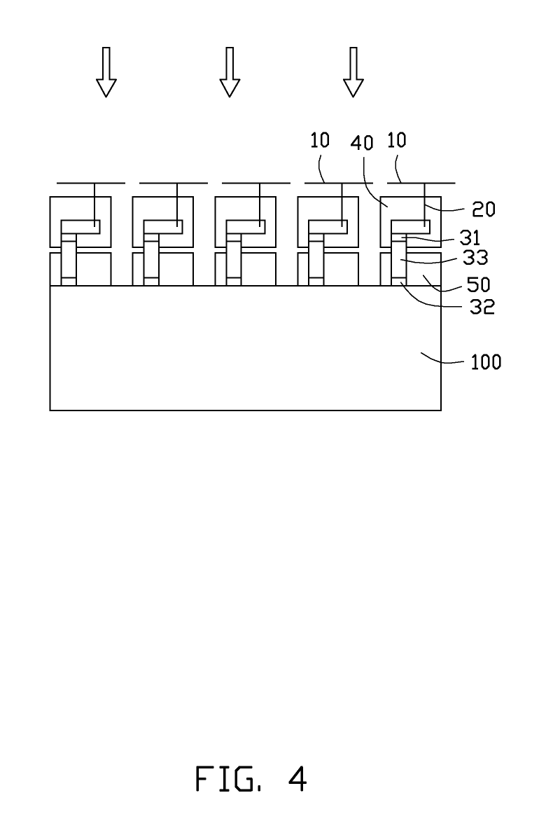

Referring to FIG. 4, in use, the second movable member 50 is located at one side of the container 100. The second mounting end 32 communicates with the inside of the container 100. The collecting member 10 can face and collect airflow flowing toward the side of the container 100. The air flows through the first duct 20 and the second duct 30 to go into the container 100.

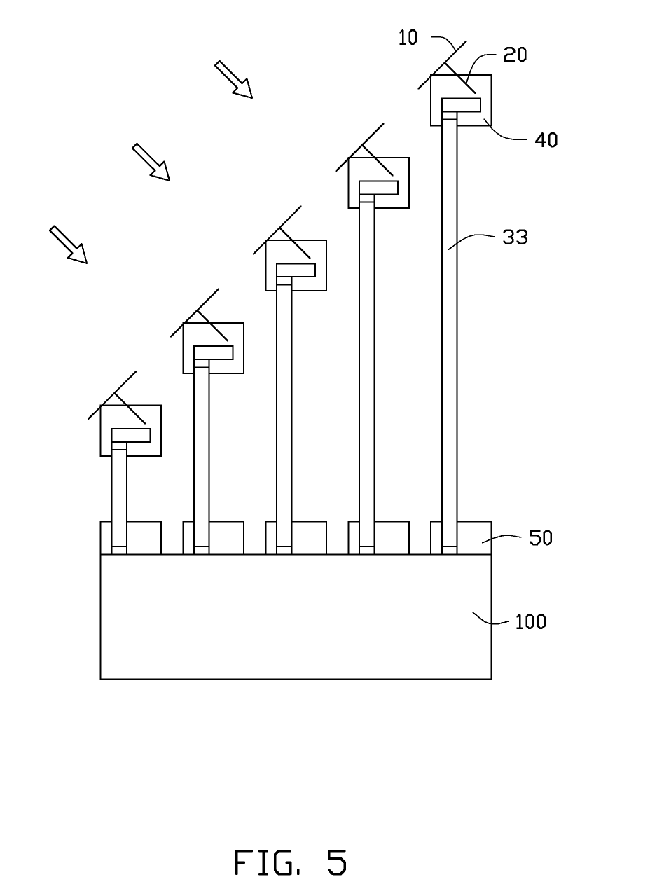

Referring to FIG. 5, when airflow slantingly flows toward the side of the container 100, the first duct 20 is pivoted to adjust the direction of the collecting member 10 until the collecting member 10 faces and collects the airflow. The air flows through the first duct 20 and the second duct 30 to go into the container 100. The first movable members 40 can be adjustably distanced from the corresponding second movable members 50 to stagger the collecting members 10, and for preventing the collecting members 10 from interfering with each other.

In this embodiment, the air collecting device 200 can adjust the direction of the collecting member 10 to collect the airflow, which can utilize natural wind effectively.

Even though numerous characteristics and advantages of the embodiments have been set forth in the foregoing description, together with details of the structure and function of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A container data center, comprising:
a container; and
an air collecting device comprising a collecting member to collect airflow, a first duct comprising a first end and a second end, and a second duct comprising a third end and a fourth end, wherein the first end connected to the collecting member, the fourth end connected to the container and communicating with an inside of the container, the second end of the first duct pivotably connected to the third end of the second duct opposite to the container.

2. The container data center of claim 1, wherein the first duct comprises a straight portion connected to the collecting member, and a curved portion connected to the straight portion opposite to the collecting member, the second duct comprises a first mounting end povotably connected to the curved portion, a second mounting end connected to the container, and a stretchable portion connected between the first mounting end and the second mounting end.

3. The container data center of claim 2, wherein a connecting portion is connected between the curved portion and the first mounting end, the connecting portion comprises a first curved section pivotably connected to the curved portion, a second curved section connected to the first mounting end, and a straight section connected between the first curved section and the second curved section.

4. The container data center of claim 3, wherein the air collecting device further comprises a first movable member and a second movable member, two first supporting portions with arc-shaped top surfaces protrude from the first movable member, for respectively mounting the first mounting end and the connecting portion, a second supporting portion with an arc-shaped top surface protrudes from the second movable member, for mounting the second mounting end.

5. The container data center of claim 4, wherein the stretchable portion is stretchable to move the first movable member away from the second movable member.

6. The container data center of claim 4, wherein the first movable member and the second movable member are both small carts.

7. The container data center of claim 1, wherein the collecting member is horn-shaped.
